(19) United States
(12) Patent Application Publication
(10) Pub. No.: US 2004/0206746 A1
(43) Pub. Date: Oct. 21, 2004

(54) Ceramic heater

(75) Inventor: Yanling Zhou, Ibi-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: IBIDEN CO., LTD., Ogaki-shi (JP)

(21) Appl. No.: 10/842,482

(22) Filed: May 11, 2004

Related U.S. Application Data
(62) Division of application No. 09/869,321, filed on Oct. 18, 2001.
Application No. 09/869,321 is a 371 of international application No. PCT/JP00/08226, filed on Nov. 22, 2000.

(30) Foreign Application Priority Data
Nov. 24, 1999 (JP) 11/332800
Feb. 7, 2000 (JP) 2000-29281
Nov. 17, 2000 (JP) 2000-351503

(51) Int. Cl. H05B 3/68

(52) U.S. Cl. 219/444.1

(57) ABSTRACT

An objective of the present invention is to provide a ceramic heater having good temperature controllability, wherein a ceramic substrate is used as a base material of the heater, and a resistance heating element having superior durability such as superior oxidization resistance is set up. The ceramic heater of the present invention is characterized in that a resistance heating element composed of one circuit or more circuits is arranged on a ceramic substrate and an insulating covering is deposited on the resistance heating element.

### TECHNICAL FIELD

The present invention relates to a semiconductor producing or examining ceramic heater used mainly in the semiconductor industry.

### BACKGROUND ART

Semiconductor-applied products are very important products necessary in various industries. A semiconductor chip, which is a typical product thereof, is produced, for example, by slicing a silicon monocrystal into a given thickness to produce a silicon wafer, and then forming various circuits etc. on this silicon wafer.

In order to form the various circuits and so on, it is necessary to apply a photosensitive resin onto the silicon wafer, expose the resin to light, develop the exposed resin, and then subject the resultant to post-curing, or sputtering to form a conductor layer. For this purpose, it is necessary to heat the silicon wafer.

The semiconductor wafer, such as a silicon wafer, is put on a heater and is heated. Hitherto, as this kind of heater, a heater wherein a resistance heating element such as an electrical resistor is set on the back surface of a substrate made of aluminum has been frequently employed. However, the substrate made of aluminum needs to have a thickness of about 15 mm. As a result, the substrate has a large weight and is bulky so that handling thereof is not necessarily satisfactory. Moreover, the temperature controllability thereof is insufficient in the point that the temperature thereof does not follow the applied current satisfactorily. Thus, it has been difficult that the semiconductor wafer is uniformly heated.

In a heater used in such a semiconductor producing device, the surface of its resistance heating element is easily affected by light, heat, treating gas and the like when the semiconductor producing device is used. Thus, resistance against oxidization is required for the surface of the resistance heating element.

### SUMMARY OF THE INVENTION

In light of the above-mentioned problems, the present invention has been completed. An objective thereof is to provide a ceramic heater having good temperature controllability, wherein a ceramic substrate is used as the base material of the heater and a resistance heating element having superior durability such as superior oxidization resistance is set up.

The ceramic heater of the present invention is a ceramic heater wherein a resistance heating element comprising one circuit or more circuits is arranged on a ceramic substrate and an insulating covering is deposited on the resistance heating element.

In the ceramic heater, instead of a metal coating film formed by plating, the insulating covering is deposited on the surface of the resistance heating element. Therefore, when a voltage of 30 to 300 V is applied to the resistance heating element, this insulating covering makes it possible to protect the resistance heating element without causing an inconvenience that electric current flows through the surface of the resistance heating element. Also, even if the temperature of the surface of the resistance heating element is risen by the application of the voltage, the resistance heating element is not easily oxidized and thus, a change in the resistance of the resistance heating element and so on can be prevented since the resistance heating element is covered with the insulating covering.

In the case that the insulating covering is deposited in a stretch containing a portion where the above-mentioned circuit is formed, particularly, so as to cover the resistance heating element comprising two or more circuits in a lump, besides the above-mentioned advantageous effects, it is possible to prevent the generation of short circuits and so on in the resistance heating element based on migration of a constituting metal (for example, silver and the like)of a resistance heating element. When the insulating covering is to be formed in the above-mentioned stretch, the covering layer can easily be formed in the stretch containing the portion where the above-mentioned circuit is formed, by screen printing or the like. Thus, covering costs are reduced so that an inexpensive heater is produced.

The ceramic substrate which constitutes the ceramic heater of the present invention is preferably comprising a nitride ceramic or a carbide ceramic. A nitride ceramic and a carbide ceramic are superior in thermal conductivity, which is the characteristic that heat of the resistance heating element is conducted, and are also superior in resistance against corrosion with treating gas in a semiconductor producing device. Thus, these ceramics are suitable for substrates for heaters.

In the ceramic heater of the present invention, its insulating covering may be comprised of oxide glass. This is because oxide glass which can be applied to these uses has a large adhesion strength to the ceramic substrate and the resistance heating element, chemical stability, and good electrical insulation.

In the ceramic heater of the present invention, the insulating covering can be comprised of a heat resistant resin material. This is because the heat resistant resin material which can be applied to these uses also has a large adhesion strength to the ceramic substrate and the resistance heating element and has good electrical insulation and further this material can be formed at a relatively low temperature. The heat resistance means that it can be used at a temperature of 150° C. or higher.

As the heat resistant resin material, at least one of a polyimide resin and a silicone resin can be selected.

In the ceramic heater of the present invention, the opposite side to the side where the resistance heating element is formed is a heating surface. A semiconductor wafer is desirably handled on this heating surface side. The reason for this is as follows: heat generated by the resistance heating element is diffused while conducted through the ceramic substrate, so that temperature distribution similar to the pattern of the resistance heating element is not easily generated on the heating surface and heat uniformity on the heating surface can be ensured.

A semiconductor wafer may be put on the heating surface, or may be held at about 50 to 200 μm apart from the heating surface by supporting pins and the like and be heated.

JP Kokai Hei 6-13161 discloses a structure wherein a ceramic substrate is covered with a resin, but in this publication an object to be heated is put on a heating element. Hence, this is entirely different from the present invention in concept.

Japanese Patent gazette No.2724075 discloses a method for covering a surface of a sintered body of an aluminum nitride with a metal layer, by applying and sticking alkoxide, metal powder and glass powder to the surface and then firing the resultant. However, this patent is related to a semiconductor package, and not related to such a ceramic heater as in the present invention. Thus, the present invention is not rejected its novelty.

### BRIEF DESCRIPTION OF DRAWINGS

FIG. 1 is a bottom surface view that schematically illustrates one embodiment of the ceramic heater according to the present invention.

FIG. 2 is a partially enlarged sectional view that illustrates a part of the ceramic heater illustrated in FIG. 1.

FIG. 3 is a bottom surface view that schematically illustrates another embodiment of the ceramic heater according to the present invention.

FIG. 4 is a partially enlarged sectional view that illustrates a part of the ceramic heater illustrated in FIG. 3.

FIG. 5 is a bottom surface view that schematically illustrates further another embodiment of the ceramic heater according to the present invention.

Explanation of symbols

| | |
|---|---|
| 10, 20, 30 | a ceramic heater |
| 11, 21 | a ceramic substrate |
| 11a, 21a | a heating surface |
| 11b, 21b | a bottom surface |
| 12, 22 (22a, 22b, 22c and 22d) | a resistance heating element(s) |
| 13, 23 | an external terminal |
| 14, 24 | a bottomed hole |
| 15, 25 | a through hole |
| 16 | a lifter pin |
| 17, 27 (27a, 27b, 27c and 27d), 37 | a insulating covering(s) |
| 19 | a silicon wafer |

### DETAILED DISCLOSURE OF THE INVENTION

Referring to the drawings, embodiments of the ceramic heater of the present invention will be described hereinafter.

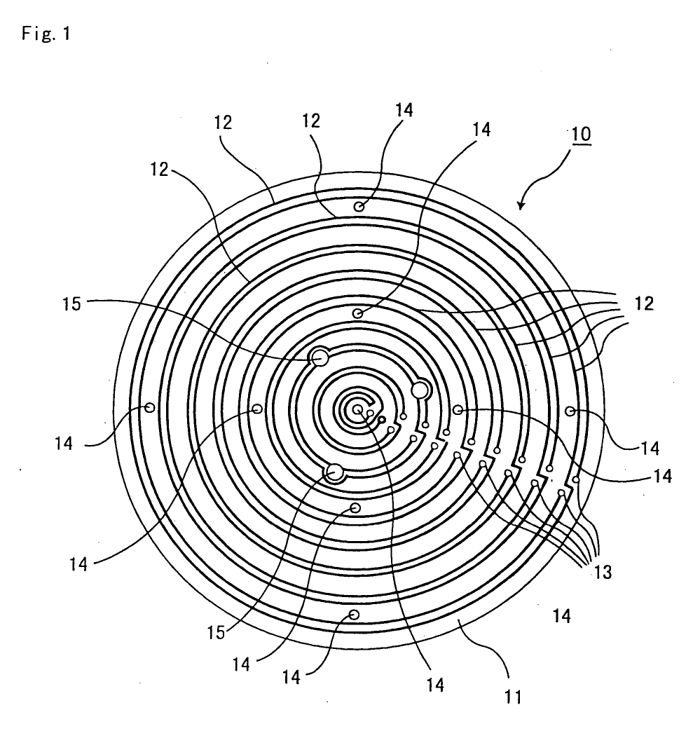

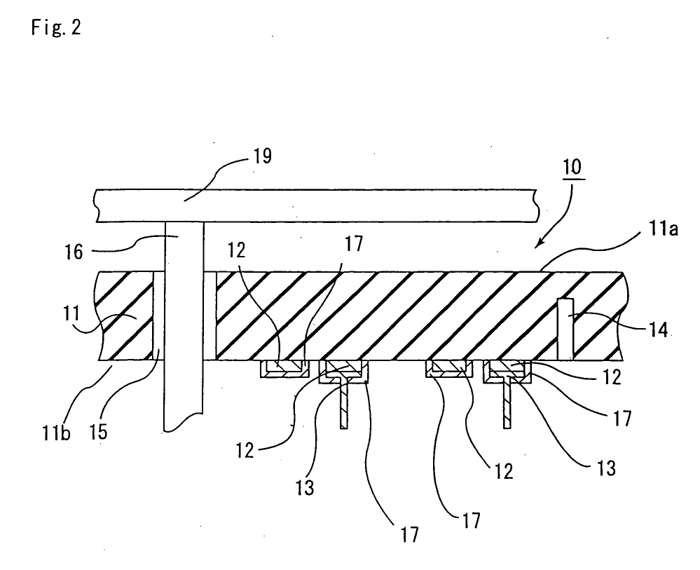

FIG. 1 is a bottom surface view that schematically illustrates one embodiment of the ceramic heater of the present invention. FIG. 2 is a partially enlarged sectional view of this ceramic heater.

This ceramic heater 10 is constituted as follows. A plate form ceramic substrate 11 comprising an insulating nitride ceramic or carbide ceramic is used. Substantially linear resistance heating elements 12 are arranged, for example, into the form of concentric circles illustrated in FIG. 1, on a main surface of this ceramic substrate 11 so as to make circuits. An object to be heated, for example a silicon wafer 19, is put on another main surface (which is referred to as a heating surface, hereinafter) 11a, or the object is held at a given distance apart from the heating surface 11a, so as to be heated.

As illustrated in FIG. 2, through holes 15 are formed in portions near the center of the ceramic substrate 11, and lifter pins 16 are inserted through the through holes 15 so that the silicon wafer 19 is supported. Bottomed holes 14 into which temperature measuring elements such as thermocouples are inserted are made in a bottom surface 11b.

As illustrated in FIG. 2, by depositing insulating coverings 17 having a given thickness on surface portions of the resistance heating elements 12 on this ceramic heater 10, durability such as oxidization resistance is improved. Incidentally, in this ceramic heater 10, an external terminal 13 is connected to an end portion of each resistance heating element 12, and the insulating covering 17 is also formed on a part of the external terminal 13. This case is normally done by connecting the external terminal 13 to the end portion of the resistance heating element 12 first, and subsequently forming the insulating covering 17.

In the case that the insulating covering 17 is formed before the connection of the external terminal 13, no insulating covering 17 can be deposited on the portion where the external terminal 13 is connected. In this case, therefore, no insulating covering 17 can be formed on the portion where the external terminal 13 is connected. However, it is allowable to connect the external terminal 13, subsequently carry out covering again to form the insulating covering 17 on the portion where the external terminal 13 is connected.

A conventional ceramic heater wherein resistance heating elements are formed on a surface of a ceramic substrate has the following problem to be overcome: heat is radiated from the exposed surface of the resistance heating elements so that the temperature of the heating surface does not rise for the amount of a supplied electric power. However, in the present invention, the insulating coverings 17 are formed so that heat radiation from the resistance heating elements 12 is small and heat is effectively generated for a supplied electric power. Thus, a high surface temperature can be kept.

As the insulating coverings 17, an oxide glass material, or an electrically insulated synthetic resin having heat resistance (referred to a heat resistant resin, hereinafter), such as a polyimide resin or a silicone resin may be employed. Only one of these materials may be used, or two or more thereof may also be used together (in overlapping layers and the like). These materials will be described later.

In the following description, a case in which an aluminum nitride sintered body substrate is used as a base material of a ceramic substrate will be explained. However of course, the base material is not limited to aluminum nitride, and examples of the base material include carbide ceramics, oxide ceramics, and nitride ceramics and the like, other than aluminum nitride.

Examples of the carbide ceramics may be metal carbide ceramics such as silicon carbide, zirconium carbide, titanium carbide, tantalum carbide and tungsten carbide. Examples of the oxide ceramics may be metal oxide ceramics such as alumina, zirconia, cordierite and mullite. Examples of the nitride ceramics may be metal nitride ceramics such as aluminum nitride, silicon nitride, boron nitride and titanium nitride.

Among these ceramics, the nitride ceramics and the carbide ceramics are preferred to the oxide ceramic since the thermal conductivity thereof is in general higher than that of the oxide ceramics. These materials of the sintered body substrate may be used alone or in combination of two or more.

The ceramic heater employing the nitride ceramic, a typical example of which is aluminum nitride, and the carbide ceramic has a small thermal expansion coefficient than metals and has a high rigidity value. Therefore, even if the ceramic heater has a small thickness, no warp nor strain is generated therein so that the heater substrate can be made thinner and lighter compared to the case that heater substrates of a metal material such as aluminum is employed. In particular, aluminum nitride is superior in thermal conductivity, is not easily affected by light and heat inside a semiconductor producing device and is superior in resistance against corrosion with treating gas and the like; therefore, aluminum nitride can be preferably used as a heater.

An insulating layer may be formed on the surface of the ceramic substrate comprising the above-mentioned nitride ceramic or carbide ceramic.

If a resistance heating element is directly formed on the surface of the ceramic substrate, a leakage current is generated between the neighboring resistance heating elements in the case that the ceramic substrate itself has a large electrical conductivity at room temperature or has a reduced resistance at a high temperature range. Thus, the ceramic substrate may not function as a heater.

In this case, an insulating layer is formed on the surface of the ceramic substrate, the resistance heating element is formed on the insulating layer, and then the insulating covering is deposited on the resistance heating elements further more.

As the insulating layer, for example, an oxide ceramic is used. Examples of such an oxide ceramic include silica, alumina, mullite, cordierite and beryllia. These oxide ceramics may be used alone or in combination of two or more.

Examples of the method for forming the insulating layer comprising such a material include a method of using a sol solution wherein alkoxide is hydrolyzed to form a covering layer by spin coating or the like, and then drying and firing the covering layer. The insulating layer may be formed by CVD or sputtering, or by applying glass powder paste and firing the paste at 500 to 1000° C.

The resistance heating elements 12 are formed by applying a conductor containing paste containing particles of a metal such as a noble metal (gold, silver, platinum or palladium), lead, tungsten, molybdenum or nickel on a surface of the ceramic substrate to form a conductor containing paste layer having a given pattern, and subsequently baking the paste thereon to sinter the metal particles. The sintering of the metal particles is sufficient if the metal particles are melted together and adhered to each other, and the metal particles and the ceramic substrate are melted together and adhered to each other. The resistance heating elements 12 may be formed by employing particles of a conductive ceramic such as tungsten carbide or molybdenum carbide.

When the resistance heating elements 12 are formed, their resistance value can be set to any one of various values by controlling the shape (width of the line and thickness) thereof. As is well known, the resistance value can be made higher as the width thereof is made narrower or the thickness thereof is made thinner. The form of the resistance heating elements is a substantially straight line or curved line, and needs not to be a straight line or curved line in a geometrically strict sense. The form may be a combination of a straight line and a curved line.

The oxide glass material, which is a material of the insulating coverings, has a high electrical insulation for itself, and has a large adhesion strength to the ceramic substrate and the resistance heating elements. It also superior in chemical stability. Therefore, the oxide glass material can compose a stable interface with the ceramic substrate and a stable interface with the resistance heating elements.

Specific examples of the composition thereof include: ZnO—B₂O₃—SiO₂ whose main component is ZnO; and PbO—SiO₂, PbO—B₂O₃—SiO₂ or PbO—ZnO—B₂O₃ whose main components are PbO. These oxide glass materials may have a crystalline part. The glass-transition point of these glass materials is 400 to 700° C., and the thermal expansion coefficient thereof is 4 to 9 ppm/° C.

The method for forming the insulating coverings comprising such an oxide glass material includes a method of applying a paste containing the above-mentioned oxide glass powder to the surface of the ceramic substrate by screen printing or the like, and then drying and firing the resultant, so as to form the insulating coverings. In this case, on portions where the external terminals are formed, it is necessary to form, layers comprising a resin or the like which decomposes relatively easily upon heating, so as not to form the insulating coverings on the portions.

The heat resistant resin material, which is a material for the insulating coverings, has good electrical insulation, and has large adhesion strength to the ceramic substrate and the resistance heating elements so that the heat resistant resin material can constitute a stable interface with the ceramic substrate and a stable interface with the resistance heating elements. The use of the heat resistant resin material makes it possible to form the insulating coverings at a relatively low temperature. When the insulating coverings are formed, what is necessary to do is just apply the heat resistant resin material to a surface of a resistance heating element, and dry and solidify it. Hence, the insulating coverings can easily be formed at inexpensive costs. Herein, the heat resistance means that it can be used at a temperature of 150° C. or higher without causing deterioration and so on of the-polymers.

Specific examples thereof include a polyimide resin and a silicone resin. A polyimide resin is a polymer compound obtained by a reaction of a carbonic acid derivative with a diamine; it has heat resistance of 200° C. or higher and can be used in a wide temperature range. A silicone resin is polysiloxane wherein as alkyl groups of their side chains, methyl or ethyl groups are arranged; it has superior heat resistance, rubber elasticity and good adhesion to the resistance heating elements and the ceramic substrate. By drying and solidifying a silicone resin at a relatively low temperature of about 150 to 250° C., the insulating coverings can be formed.

As the method for forming the insulating covering comprising such a heat resistant resin material, a method of applying or spraying a paste wherein the heat resistant resin material is dissolved in a solvent, to a surface of the ceramic substrate, and then drying the paste, so as to form the insulating covering: is listed.

In this ceramic heater 10, the insulating coverings 17 are formed on the surface portions of the resistance heating elements 12. The thickness of the insulating coverings 17 is desirably 5 to 20 μm in the case of the oxide glass, and the thickness is desirably 10 to 30 μm in the case of the heat resistant resin.

This is because; after heating of the ceramic heater 10, cooling is necessary in order to return the temperature to ambient temperature. If the insulating coverings 17 are too thick, much time is required for the cooling so that productivity is lowered. If the insulating coverings 17 are too thin, the oxidization resistance is lowered and the temperature of the heating surface falls because of heat radiated from the exposed surface of the resistance heating elements.

Thus, in the case that the insulating coverings are deposited on the surface of the resistance heating elements in this way, a leakage current does not flow through the insulating coverings even if a voltage of about 30 to 300 V is applied to the resistance heating element, also, the surface of the resistance heating elements is protected by it. This is because these materials have superior electrical insulation.

Furthermore, since the above-mentioned ceramic substrate can have a high thermal conductivity and be formed to have a thin thickness, the surface temperature of the ceramic substrate follows a change in the temperature of the resistance heating element quickly, consequently the ceramic heater 10 has superior temperature controllability and durability.

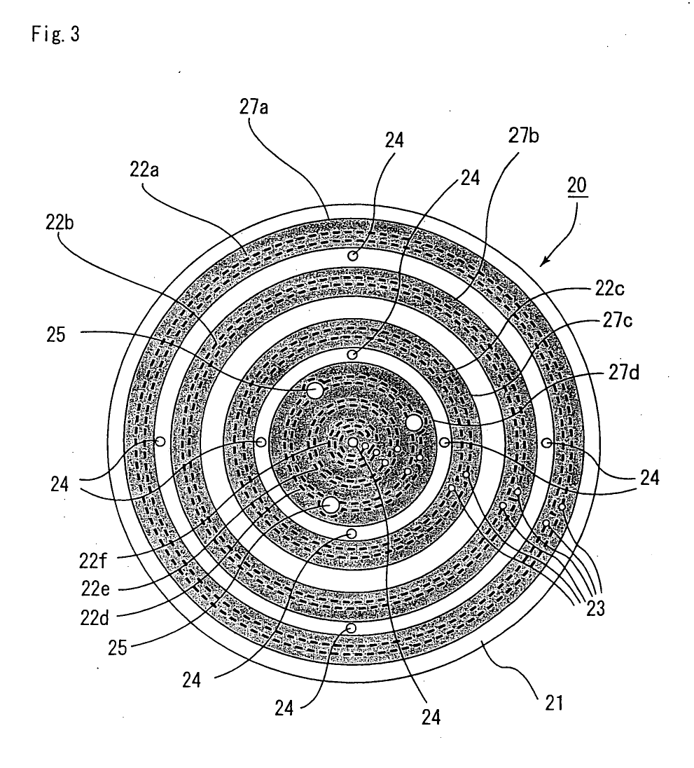

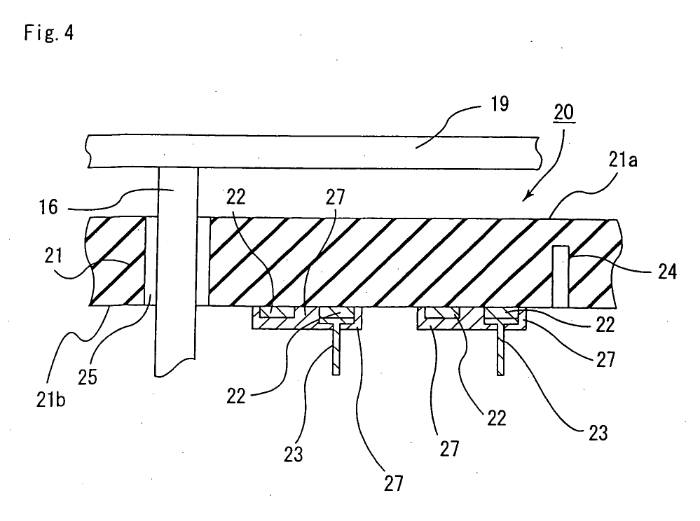

FIG. 3 is a bottom surface view that schematically illustrates another embodiment of the ceramic heater of the present invention. FIG. 4 is a partially enlarged sectional view of this ceramic heater.

In the same manner as in the case of the ceramic heater 10 illustrated in FIG. 1, this ceramic heater 20 is constituted as follows. A plate-form ceramic substrate 21 is used. Substantially linear resistance heating elements 22 (22a to 22f) are arranged, for example, into the form of concentric circles illustrated in FIG. 1, on a main surface of this ceramic substrate 21 so as to make circuits. An object to be heated is put on another main surface, or the object is held at a given distance apart from the heating surface 21a, so as to be heated.

According to this ceramic heater 20, in stretches comprising portions where the circuits are formed, the insulating layer is formed, that is:

around resistance heating elements 22a, 22b and 22c where the distance between the circuits are relatively wide, insulating coverings 27a, 27b and 27c are deposited in each stretch of the areas sandwiched between each resistance heating element constituting the circuits and the peripheries of each circuit thereof;

around resistance heating elements 22d, 22e, 22f where the distance between the circuits are narrow, on the other hand, an insulating covering 27d is deposited in the whole stretch of the areas sandwiched between the resistance heating element constituting the circuits, the peripheries of each circuit thereof, and the areas among the respective circuits.

The ceramic heater 20 having such a structure can produce the same advantageous effects as seen in the case of the ceramic heater 10 illustrated in FIG. 1, and can prevent the neighboring circuits from being short-circuited by migration of metal particles (for example, silver particles) contained in the resistance heating elements 22. When the insulating coverings 27 are formed, it is sufficient to form applied layers in the given areas by screen-printing or the like, and heating the applied layers to form the insulating coverings 27. Thus, the ceramic heater can be relatively easily and efficiently formed. As a result, covering costs are reduced and the heater becomes inexpensive.

In the same manner as in the case of the ceramic heater illustrated in FIG. 1, as the insulating coverings 27, there may be used any one of oxide glass materials or a heat resistant resin such as a polyimide resin and a silicone resin.

In the same manner as in the case of the ceramic heater illustrated in FIG. 1, as the material for the base material of the ceramic substrate, there may be used, for example, a carbide ceramic, an oxide ceramic, a nitride ceramic and the like.

As the material of the resistance heating elements 22, there may be used the same material as in the case of the ceramic heater 10 illustrated in FIG. 1. The same method as in the case of the ceramic heater 10 illustrated in FIG. 1 is used to make it possible to form the resistance heating elements 22.

In this ceramic heater 20, the thickness of the insulating coverings 27 (the thickness from the surface of the resistance heating elements 22) is desirably the same as in the case of the ceramic heater 10 illustrated in FIG. 1. The thickness, from the bottom surface of the ceramic substrate 21, of portions where no resistance heating elements 22 are formed is desirably 5 to 100 μm, more desirably 10 to 30 μm in the case of the oxide glass. The thickness is desirably 10 to 50 μm in the case of the heat resistant resin.

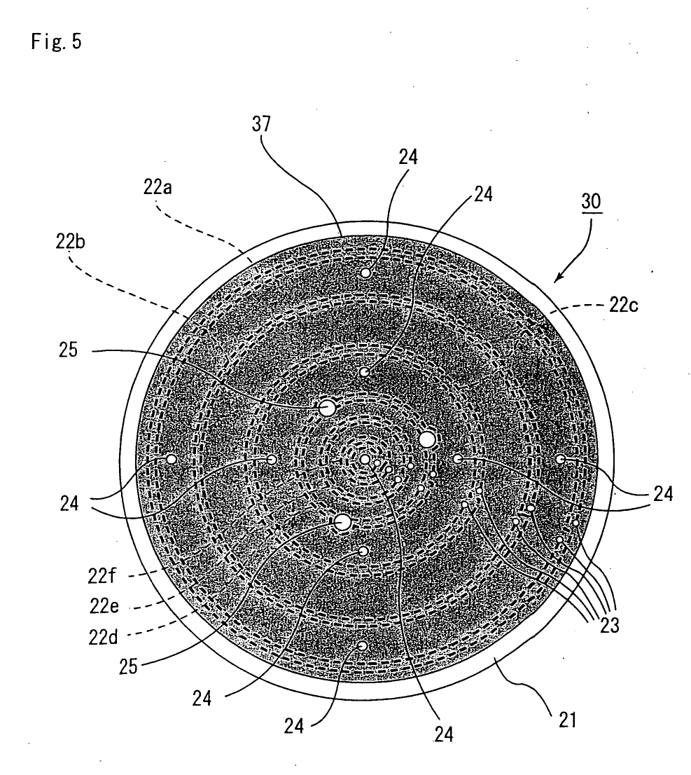

FIG. 5 is a bottom surface view that schematically illustrates further another embodiment of the ceramic heater according to the present invention.

This ceramic heater 30 has the same structure as the ceramic heater 20 except that the insulating covering 37 is formed in the whole stretch of areas where the resistance heating elements 22 of the ceramic heater 20 are formed. The ceramic heater can produce the same advantageous effects as seen in the case of the ceramic heater 10 illustrated in FIG. 1, and can prevent the neighboring circuits, from being short-circuited by migration of metal particles (for example, silver particles) contained in the resistance heating elements 22. When the insulating covering 37 is formed, it is sufficient to form applied layers in the given areas by screen-printing or the like, and heat the applied layers to form the insulating coverings 27. Thus, the ceramic heater can be easily and efficiently formed. As a result, covering costs are reduced and the heater becomes inexpensive.

As described above, the insulating covering in the present invention can have various structures as follows:

the structure of covering only the surface of the circuit;

the structure of covering stretches containing a portion where the circuit is formed;

the structure of covering two or more neighboring circuits in the diameter direction of the ceramic substrate, in a lump; and

the structure of covering the whole of area where the circuits are formed.

Concerning the ceramic heater of the present invention, the ceramic heater having the structure of covering the whole of area where the circuits are formed by the insulating covering is superior in temperature stability of the heating surface because the temperature of the circuits is retained. However, time for cooling the ceramic substrate becomes long because the thermal capacity of the insulating covering is large. On the other hand, in the ceramic heater having the structure of covering only the surface of the circuits by the insulating coverings, the insulating coverings have a small thermal capacity. Therefore, the cooling time can be made short, but temperature stability on the heating surface is poor.

Therefore, from the standpoint of making the time for cooling ceramic substrate short, the ceramic heater having the structure of covering only the surface of the circuits by the insulating coverings is desired. From the standpoint of the temperature stability of the heating surface, the ceramic heater having the structure of covering the whole of area where the circuits are formed by the insulating covering is desired.

On the other hand, more desired are; the ceramic heater having the structure of covering stretches containing a portion where the circuit is formed by the insulating covering, and the ceramic heater having the structure of covering two or more neighboring circuits in the diameter direction of the ceramic substrate, in a lump by the insulating covering but for not covering the whole of the circuits. This is because they make it possible to make the cooling time short and, at the same time, ensure the temperature stability in the heating surface.

### BEST MODES FOR CARRYING OUT THE INVENTION

The following will describe specific examples and production processes of the ceramic heater according to the present invention. In the following description, step conditions are mere examples and can be set with an appropriate change depending on the size of samples and the amount to be treated.

### EXAMPLE 1

The following were mixed and kneaded to form a slurry, and then the slurry was sprayed by a spray-dry method to prepare granular powder: 100 parts by weight of aluminum nitride powder (average particle diameter: 1.1 μm), 4 parts by weight of yttria (average particle diameter: 0.4 μm), 12 parts by weight of an acrylic resin binder, and alcohol.

Next, the granular powder was put into a forming mold to be formed into a plate form. Thus, a raw formed body was formed. This raw formed body was subjected to hot press at about 1800° C. and a pressure of 20 MPa to obtain a plate-form sintered body comprising aluminum nitride and having a thickness of 3 mm. This was cut off into a disc having a diameter of 210 mm. Thus, a ceramic substrate 11 for a ceramic heater (reference to FIG. 1) was prepared.

Next, holes were drilled in the ceramic substrate 11 to make portions which would be through holes 15 into which lifter pins 16 for semiconductor wafers were inserted and bottomed holes 14 in which thermocouples were buried.

A conductor containing paste was printed on the ceramic substrate 11 subjected to the above-mentioned processing, by screen printing, in the manner that the linear resistance heating elements 12 having the pattern illustrated in FIG. 1 would be formed. The conductor containing paste used herein was Solvest PS603D (trade name) made by Tokuriki Kagaku Kenkyu-zyo. This conductor containing paste was the so-called silver paste containing a metal oxide comprising a mixture of lead oxide, zinc oxide, silica, boron oxide and alumina (the weight ratio thereof was 5/55/10/25/10 in accordance with the order) in amount of 7.5% by weight of silver. The average particle diameter of silver was 4.5 μm, and the shape thereof was mainly scaly.

The heater substrate 11 on which the conductor containing paste was printed in this way was heated and fired at 780° C. to sinter silver in the conductor containing paste and bake it onto the heater plate 11. At this time, the resistance heating elements 12 formed by employing the sintered silver had a thickness of about 10 μm, a width of about 2.4 mm and an area resistivity of 5 mΩ/□.

Thereafter, insulating coverings 17 comprising an oxide glass material were formed on the surface of the resistance heating elements 12.

First, to 87 parts by weight of glass powder having a composition of 30% by weight of PbO, 50% by weight of SiO₂, 15% by weight of B₂O₃, 3% by weight of Al₂O₃ and 2% by weight of Cr₂O₃ added were 3 parts by weight of a vehicle and 10 parts by weight of a solvent, to prepare a pasty mixture.

Next, this pasty mixture was used to perform screen printing to cover the surface of the resistance heating elements 12. Thus, a layer of the pasty mixture was formed. Thereafter, this pasty mixture was dried and firmly adhered thereto at 120° C., and the mixture was heated at 680° C. in the atmosphere of air for 10 minutes to be melted and bonded onto the surface of the resistance heating elements 12 and the ceramic substrate 11. Thus, the insulating coverings 17 were formed. At this time, the thickness of the insulating coverings was 10 μm. However, no insulating coverings 17 were formed on connecting portions of external terminal 13 at both ends of the circuit comprising the resistance heating elements 12. Therefore, the condition of the coverings near the external terminals was different from that of the ceramic heater 10 illustrated in FIG. 2.

Upon the melting and bonding by heating, it is allowable to use a method of pre-forming the mixture beforehand into a shape suitable for the shape of the insulating coverings 17, and then putting this pre-formed body on the resistance heating elements 12, and conduct heating.

Next, by screen printing, a silver-containing lead solder paste (made by Tanaka Kikinzoku Kogyo CO.) was printed on portions of the resistance heating elements 12, to which external terminals 13 were attached, to form a solder layer. Furthermore, the external terminals 13 made by koval were put on the solder layer, and the solder layer was heated and reflowed at 420° C. to connect and fix the external terminals 13 to the both ends of the respective resistance heating elements 12.

As illustrated in FIG. 2, it is allowable to connect the resistance heating elements 12 and the external terminals 13 at first, and subsequently form the insulating coverings 17 to cover even portions where the external terminals 13 were formed as well as the area of the resistance heating elements 12.

Thereafter, thermocouples for temperature-control (not illustrated) were buried in the bottomed holes 14 in the ceramic substrate to obtain the ceramic heater 10 illustrated in FIGS. 1,2.

Since the resistance heating elements 12 have a given resistance value, the resistance heating elements 12 generate Joule heat to heat a semiconductor wafer 19 if electric current is sent thereto.

After the ceramic heater 10 using the aluminum nitride substrate 11 was produced as described above, the thermal expansion coefficient and the area resistivity of the insulating covering material used in this ceramic heater 10 were measured. The oxidization resistance of the resistance heating elements was also examined.

The temperature of the ceramic heater 10 was raised to 200° C. and the heating surface was observed with a thermoviewer to measure a change in the temperature of any one point for 10 hours and examine a temperature change with the passage of time. Furthermore, air was blown onto the ceramic heater 10 at the rate of 0.1 m³/minute to measure a time required until the temperature of the heating surface dropped to 50° C. The results are shown in Table 1.

The area resistivity was measured at D.C. 100 V and room temperature. The oxidization resistance was evaluated by examining a change in the resistance of the heater which went through aging treatment at 20° C. for 1000 hours. The temperature change with the passage of time was represented by a difference between the highest temperature and the lowest temperature during the measurement for 10 hours.

Measurement as to whether migration was generated or not was performed by the following method.

Namely, the resultant ceramic heater 10 was heated up to 200° C. at a humidity of 100% and electric current was sent thereto for 48 hours, to examine whether metal-diffusion between the resistance heating elements was caused or not by means of an X-ray fluorescence analyzer (EPM-810S made by Shimadzu Corp.).

### EXAMPLE 2

A ceramic heater was produced and evaluated in the same way as in Example 1 except that instead of the oxide glass material, a heat resistant resin material (a polyimide resin) was used to form the insulating coverings 17 by the following method. The results are shown in Table 1.

Namely, a pasty or mucous solution of a mixture of 80% by weight of aromatic polyimide powder and 20% by weight of polyamide acid was first prepared, and subsequently this solution of the mixture was selectively applied to cover the surface of the resistance heating elements 12. Thus, a layer of the mixture was formed on the surface of the resistance heating elements 12.

Thereafter, the formed layer of the mixture was heated at 350° C. in a continuous firing furnace to dry and solidify the layer. Thus, the layer was melted and adhered to the surface of the resistance heating elements 12 and the ceramic substrate 11. At this time, the thickness of the formed insulating coverings 17 was 10 μm.

### EXAMPLE 3

A ceramic heater was produced and evaluated in the same way as in Example 1 except that instead of the oxide glass material, a heat resistant resin material (a silicone resin) was used to form the insulating coverings 17 by the following method. The results are shown in Table 1.

Namely, the silicone resin of a methylphenyl type was selectively applied by a metal mask printing method or the like to cover the surface of the resistance heating elements 12. The resin was heated at 220° C. in an oven to be dried and solidified. Thus, the resin was melted and adhered to the surface of the resistance heating elements 12 and the ceramic substrate 11. At this time, the thickness of the formed insulating coverings 17 was 15 μm.

### EXAMPLE 4

A ceramic heater was produced and evaluated in the same way as in Example 1 except that the resistance value of the linear resistance heating elements was made high in the present example. The results are shown in Table 1.

This is because in the case that a voltage of 30 to 300 V is applied to raise the temperature to 200° C. or higher, it is necessary to make the resistance value high.

As the paste for the resistance heating elements, there was used a paste comprising silver: 56.5% by weight, palladium: 10.3% by weight, SiO₂: 1.1% by weight, B₂O₃: 2.5% by weight, ZnO: 5.6% by weight, PbO: 0.6% by weight, RuO₂: 2.1% by weight, a resin binder: 3.4% by weight, and a solvent: 17.9% by weight.

The pattern of the resistance heating elements had a thickness of 10 μm, a width of 2.4 mm and an area resistivity of 150 mΩ/□.

### EXAMPLE 5

A ceramic heater was produced and evaluated in the same way as in Example 4 except that instead of the oxide glass material, a heat resistant resin material (a polyimide resin) was used to form the insulating coverings 17 by the method described in Example 2. The results are shown in Table 1.

### EXAMPLE 6

A ceramic heater was produced and evaluated in the same way as in Example 4 except that instead of the oxide glass material, a heat resistant resin material (a silicone resin) was used to form the insulating coverings 17 by the method described in Example 3. The results are shown in Table 1.

### Comparative Example 1

A ceramic heater was produced and evaluated in the same way as in Example 1 except that the ceramic substrate wherein the resistance heating elements were formed was immersed into an electroless nickel plating bath to precipitate a metal layer of nickel and having a thickness of about 1 μm on the surface of the resistance heating elements. The results are shown in Table 1.

The concentrations of the respective components of the nickel plating bath were as follows: nickel sulfate, 80 g/l; sodium hypophosphite, 24 g/l; sodium acetate, 12 g/l; boric acid, 8 g/l; and ammonium chloride, 6 g/l.

### Comparative Example 2

A ceramic heater was produced and evaluated in the same way as in Example 1 except that the insulating coverings 17 were not formed at all on the surface of the resistance heating elements 12. The results are shown in Table 1.

TABLE 1

| | | | | | Oxidization | | |
|---|---|---|---|---|---|---|---|
| | | | Thermal | | resistance | | |
| | | | expansion | Area | (change in | | |
| | | | coefficient | resistivity | the | | |
| | | | of the | of the | resistance | Temperature | |
| | | | insulating | insulating | at 200° C. for | change with | Cooling |
| | Insulating coverings | | coverings | coverings | 1000 | the passage | time |
| | Kind | Composition | (ppm/° C.) | (Ω/□) | hours, %) | of time (° C.) | (sec) |
| Example 1 | Oxide | PbO—SiO₂— | 5 | 10¹⁶ | 0.2 | 0.1 | 160 |
| | glass | B₂O₃ | | | | | |
| Example 2 | Polyimide | Aromatic | 12 | 10¹⁶ | 0.3 | 0.2 | 160 |
| | resin | type | | | | | |
| Example 3 | Silicone | Methylphenyl | 13 | 10¹⁵ | 0.3 | 0.1 | 160 |
| | resin | type | | | | | |
| Example 4 | Oxide | PbO—SiO₂— | 5 | 10¹⁶ | 0.1 | 0.2 | 170 |
| | glass | B₂O₃ | | | | | |
| Example 5 | Polyimide | Aromatic | 12 | 10¹⁵ | 0.3 | 0.2 | 160 |
| | resin | type | | | | | |
| Example 6 | Silicone | Methylphenyl | 13 | 10¹⁵ | 0.3 | 0.1 | 170 |
| | resin | type | | | | | |
| Comparative | Plating | Nickel | 13.3 | 50 m | 3 | 0.5 | 150 |
| Example 1 | | | | | | | |
| Comparative | None | — | — | — | 20 | 0.5 | 150 |
| Example 2 | | | | | | | |

As is evident from the results shown in Table 1, in Examples 1 to 6, the change in the resistance of the resistance heating elements was as small as 0.1 to 0.3%. However, in Comparative Example 1, the change was as large as 3%. This would be because the resistance was changed by oxidization of the nickel plating film itself; and further oxygen diffused inside to oxidize inside silver since the nickel plating film was porous. In Comparative Example 2, no layer for covering the resistance heating elements was formed. Therefore, it was proved that the resistance change ratio of the resistance heating elements was as large as 20 to 25% and the ceramic heater was not practicable. Regarding the migration, in the ceramic heater according to Comparative Example 2, migration of Ag was generated, and there was a possibility that a short circuit between the resistance heating elements might be generated.

In the ceramic heaters according to Examples 1, 4, the thermal expansion coefficient of the oxide glass, which is the insulating coverings, was 5 ppm/° C. That of aluminum nitride was 3.5 to 4 ppm/° C. The two were numerically similar. A resistance change caused by the phenomena that metal particles constituting the resistance heating elements separate each other by expansion and contraction based on cooling and heating cycles; was smaller as compared to the cases in which the heat resistant resin was used.

In Examples 4 to 6, as the resistance heating elements, resistance heating elements having an area resistivity of 150 mΩ/□ were used. In this case, since the insulating coverings have an area resistivity of 10¹⁵ to 10¹⁶ Ω/□ so that the coverings are made to be a substantially complete insulator; therefore, even if a voltage of 50 to 200 V is applied thereto, electric current flows through only the inside of the resistance heating elements so that the calorific value thereof becomes large. However, in the case that a nickel plating film as in Comparative Example 1 is formed, the area resistivity of the nickel plating film is 50 mΩ/□, which is smaller than that of the resistance heating elements. Since electric current is conducted through a portion having a smaller resistance value, the electric currant is conducted through the nickel film so that the calorific value becomes small.

The temperature change with the passage of time of the ceramic heaters according to Examples 1 to 6 was as small as 0.1 to 0.2° C., but in Comparative Examples 1, 2, the temperature change was as large as 0.5° C. The cooling time of the ceramic heaters according to Examples 1 to 6 was 160 to 170 seconds, but that of the ceramic heaters of Comparative Examples 1, 2 was 150 seconds.

### EXAMPLE 7

In the same way as in Example 1, the ceramic substrate 21 for a ceramic heater was produced, and holes were drilled to make portions which would be the through holes 25 into which the lifter pins 16 for semiconductor wafers were inserted and the bottomed holes 24 in which thermocouples were buried.

Next, the same material as in Example 1 was used to form the resistance heating elements 22a to 22f having the shapes illustrated in FIG. 3 on the bottom surface of the ceramic substrate 21 which had went through the above-mentioned processing.

Thereafter, as illustrated in FIG. 3:

regarding the resistance heating elements 22a, 22b and 22c, the insulating coverings 27a, 27b and 27c comprising an oxide glass material were deposited in each stretch of the areas sandwiched between each resistance heating element constituting the circuits and the peripheries of each circuit thereof;

regarding the resistance heating elements 22d, 22e and 22f, the insulating covering 27d comprising the same material was deposited in the whole stretch of the areas sandwiched between the resistance heating element constituting the circuits, the peripheries of each circuit thereof, and the areas among the respective circuits.

The composition of the oxide glass material was the same as in the case of Example 1, and the method for forming the insulating coverings 27 was the same as Example 1 except that covered areas were spread over wide areas as described above. Incidentally, no insulating coverings 27 were formed in portions, at both ends of the circuit, where the external terminals were connected.

Thereafter, thermocouples for temperature-control (not illustrated) were buried in the bottomed holes 24 in the ceramic substrate to obtain the ceramic heater 20 illustrated in FIGS. 3,4.

After the ceramic heater 20 using the aluminum nitride substrate 21 was produced as described above, the thermal expansion coefficient and the area resistivity of the insulating covering material used in this ceramic heater 20 were measured. The oxidization resistance of the surface resistances was also examined.

The temperature of the ceramic heater 20 was raised to 200° C. and the heating surface was observed with a thermoviewer to measure a change in the temperature of any one point for 10 hours and examine a temperature change with the passage of time. Furthermore, air was blown onto the ceramic heater 20 at the rate of 0.1 m³/minute to measure a time required until the temperature of the heating surface dropped to 50° C. The results are shown in Table 2.

The conditions for measuring the surface resistance, the method for evaluating the oxidization resistance, and the method for evaluating the temperature change with the passage of time were the same as in Example 1.

### EXAMPLE 8

A ceramic heater was produced and evaluated in the same way as in Example 7 except that instead of the oxide glass material, a heat resistant resin material (a polyimide resin) was used to form the insulating coverings 27 by the following method. The results are shown in Table 2.

Namely, a pasty or mucous solution of a mixture of 80% by weight of aromatic polyimide powder and 20% by weight of polyamide acid was first prepared, and subsequently this solution of the mixture was applied to the same areas as in Example 7. The resultant was heated at 350° C. in a continuous firing furnace to dry and solidify the solution, then the insulating coverings 27a to 27d were formed.

### EXAMPLE 9

A ceramic heater was produced and evaluated in the same way as in Example 7 except that instead of the oxide glass material, a heat resistant resin material (a silicone resin) was used to form the insulating coverings 27 by the following method. The results are shown in Table 2.

Namely, the silicone resin of a methylphenyl type was applied to the same areas as in Example 7 by a metal mask printing method or the like. The resin was heated at 220° C. in an oven to be dried and solidified. Thus, the insulating coverings 27a to 27d were formed.

TABLE 2

| | | | | | Oxidization | | |
|---|---|---|---|---|---|---|---|
| | | | Thermal | | resistance | | |
| | | | expansion | Area | (change in | | |
| | | | coefficient | resistivity | the | | |
| | | | of the | of the | resistance | Temperature | |
| | | | insulating | insulating | at 200° C. for | change with | Cooling |
| | Insulating coverings | | coverings | coverings | 1000 | the passage | time |
| | Kind | Composition | (ppm/° C.) | (Ω/□) | hours, %) | of time (° C.) | (sec) |
| Example 7 | Oxide | PbO—SiO₂— | 5 | 10¹⁶ | 0.2 | 0 | 170 |
| | glass | B₂O₃ | | | | | |
| Example 8 | Polyimide | Aromatic | 12 | 10¹⁵ | 0.3 | 0 | 170 |
| | resin | type | | | | | |
| Example 9 | Silicone | Methylphenyl | 13 | 10¹⁵ | 0.3 | 0 | 170 |
| | resin | type | | | | | |

As is evident from the results shown in Table 2, in Examples 7 to 9, the area resistivity of the insulating coverings was also as large as 10¹⁵ to 10¹⁶ Ω/□, and the change in the resistance of the resistance heating elements covered with such insulating coverings was as small as 0.2 to 0.3%.

In Examples 8, 9, a test on oxidization resistance was performed, and subsequently the insulating coverings 27 were forcibly exfoliated from the surface of the ceramic substrate to observe whether or not migration of a metal such as silver from the surface of the resistance heating elements was caused, in the same way as in Example 1. However, no migration was caused.

Furthermore, about the ceramic heaters according to Examples 7 to 9, the temperature change with the passage of time was 0° C. and the cooling time was 170 seconds.

### EXAMPLE 10

A composition comprising the following was spray-dried to prepare granular powder: 100 parts by weight SiC powder (average particle diameter: 1.1 μm), 4 parts by weight of B₄C, 12 parts by weight of an acrylic resin binder, and alcohol.

Next, the granular powder was put into a forming mold and molded into a plate form. Thus, a formed body was formed. This formed body was subjected to hot press at about 1890° C. and a pressure of 20 MPa to obtain a plate-form sintered body comprising SiC and having a thickness of about 3 mm. The surface of this plate-form sintered body was grinded with diamond grindstones of #800 and polished with diamond paste to make Ra thereof to 0.008 μm. Furthermore, glass paste (G-5177, made by Shoei Chemical Industry Co., Ltd.) was applied to the surface thereof, and the temperature of the sintered body was raised to 600° C. to form a SiO₂ layer having a thickness of 3 μm.

This plate-form sintered body was cut off into a disc having a diameter of 210 mm to produce a ceramic substrate. A ceramic heater was then produced in the same way as in Example 1 except that the surface on which the SiO₂ layer was formed was the face on which resistance heating elements would be formed and the whole of areas in which the resistance heating elements were formed was covered with an insulating covering having a thickness of 50 μm as illustrated in FIG. 5.

After the ceramic heater using the substrate comprising SiC was produced as described above, the thermal expansion coefficient and the area resistivity of the insulating covering material used in this ceramic heater were measured. The oxidization resistance of the surface resistance thereof was also examined.

The temperature of the ceramic heater was raised to 200° C. and the heating surface was observed with a thermoviewer to measure a change in the temperature of any one point for 10 hours and examine a temperature change with the passage of time. Furthermore, air was blown onto the ceramic heater at the rate of 0.1 m³/minute to measure a time required until the temperature of the heating surface dropped to 50° C. The results are shown in Table 3.

The conditions for measuring the surface resistance, the method for evaluating the oxidization resistance, and the method for evaluating the temperature change with the passage of time were the same as in Example 1.

### EXAMPLE 11

A ceramic heater was produced and evaluated in the same way as in Example 10 except that instead of the oxide glass material, a heat resistant resin material (a polyimide resin) was used to form the insulating covering 37 by the following method. The results are shown in Table 3.

Namely, a pasty or mucous solution of a mixture of 80% by weight of aromatic polyimide powder and 20% by weight of polyamide acid was first prepared, and subsequently this solution of the mixture was applied to the whole of areas where the resistance heating elements were formed, to form a layer of the mixture.

Thereafter, the formed layer of the mixture was heated at 350° C. in a continuous firing furnace to be dried and solidified. Then, it was melted and adhered to the surface of the resistance heating elements and the ceramic substrate. At this time, the thickness of the formed insulating covering was 10 μm.

### EXAMPLE 12

A ceramic heater was produced and evaluated in the same way as in Example 10 except that instead of the oxide glass material, a heat resistant resin material (a silicone resin) was used to form the insulating covering 37 by the following method. The results are shown in Table 3.

Namely, the silicone resin of a methylphenyl type was applied to the whole of areas where the resistance heating elements were formed. The resin was heated at 220° C. in an oven to be dried and solidified to form the insulating covering 37.

After the ceramic heater using the substrate comprising SiC was produced as described above, the thermal expansion coefficient and the area resistivity of the insulating covering material used in this ceramic heater were measured. The oxidization resistance of surface resistance thereof was also examined.

The temperature of the ceramic heater was raised to 200° C. and the heating surface was observed with a thermoviewer to measure a change in the temperature of any one point for 10 hours and examine a temperature change with the passage of time. Furthermore, air was blown onto the ceramic heater at the rate of 0.1 m³/minute to measure a length of time required until the temperature of the heating surface dropped to 50° C. The results are shown in Table 3.

The conditions for measuring the surface resistance, the method for evaluating the oxidization resistance, and the method for evaluating the temperature change with the passage of time were the same as in Example 7.

TABLE 3

| | | | | | Oxidization | | |
|---|---|---|---|---|---|---|---|
| | | | Thermal | | resistance | | |
| | | | expansion | Area | (change in | | |
| | | | coefficient | resistivity | the | | |
| | | | of the | of the | resistance | Temperature | |
| | | | insulating | insulating | at 200° C. for | change with | Cooling |
| | Insulating coverings | | coverings | coverings | 1000 | the passage | time |
| | Kind | Composition | (ppm/° C.) | (Ω/□) | hours, %) | of time (° C.) | (sec) |
| Example | Oxide | PbO—SiO₂— | 5 | 10¹⁶ | 0.2 | 0 | 190 |
| 10 | glass | B₂O₃ | | | | | |
| Example | Polyimide | Aromatic | 12 | 10¹⁵ | 0.3 | 0 | 180 |
| 11 | resin | type | | | | | |
| Example | Silicone | Methylphenyl | 13 | 10¹⁵ | 0.3 | 0 | 180 |
| 12 | resin | type | | | | | |

As is evident from the results shown in Table 3, in Examples 10 to 12, the change in the resistance of the resistance heating elements was as small as 0.2 to 0.3%. About the ceramic heaters according to Examples 10 to 12, the temperature change with the passage of time was 0° C., and the cooling time was 180 to 190 seconds.

As described above, the ceramic heaters according to Examples 1 to 6 had a structure wherein only the surface of the resistance heating element was covered with the insulating coverings, and the ceramic heaters according to Examples 7 to 9 comprised: a structure wherein stretches containing the portion where the resistance heating element was formed was covered with the insulating coverings; and a structure wherein the resistance heating element comprising two or more neighboring circuits in the diameter direction of the ceramic substrate, in a lump, was covered with the insulating covering. The ceramic heaters according to Examples 10 to 12 had a structure wherein the whole of the area where the resistance heating elements were formed was covered with the insulating covering. On the other hand, the ceramic heater according to Comparative Example 1 had a structure wherein the resistance heating elements were covered with the metal, and the ceramic heater according to Comparative Example 2 had a structure wherein the resistance heating elements were not covered with any insulating covering.

The ceramic heaters according to Examples 1 to 12 were compared with each other about the temperature change with the passage of time and the cooling time. As a result, as the area covered with the insulating coverings became larger, the temperature change with the passage of time was smaller and the cooling time was longer.

Regarding the temperature change with the passage of time, it can be presumed that since the insulating coverings have an effect of keeping the temperature of the ceramic substrate itself, the temperature change is smaller as the area of the insulating coverings is larger. Regarding the cooling time, it can also be presumed that since the thermal capacity of the insulating coverings becomes larger with an increase of the area of the insulating coverings, the cooling time becomes longer.

On the other hand, in the ceramic heaters according to Comparative Examples 1, 2, the covering was performed by nickel plating or no covering was performed. Therefore, the cooling time was short, but the temperature change with the passage of time was large.

In light of the uniformity of the temperature of the heating surface and the cooling speed, the ceramic heaters wherein stretches of areas containing one circuit or more circuits where the resistance heating element is formed, were covered with the insulating coverings (reference to FIG. 3), as described in Examples 7 to 9, in which the uniformity of the temperature of the heating surface was superior and the cooling time was short; is considered to be preferable.

As is evident from the results shown in Tables 1 to 3, the ceramic heaters of the present invention have a small ratio of the resistance change and superior temperature controllability since the resistance heating elements are covered with the insulating covering. The ceramic heaters are superior in resistance against reactive gas in the semiconductor producing device.

Furthermore, the insulating covering is an insulator. Therefore, even if the resistance value of the resistance heating elements is made higher, no electric current flows through the insulating covering so that heaters having a temperature range for use of 100° C. or higher can be obtained.

In the case that the oxide glass is used for the insulating coverings, the adhesion between the oxide glass and the ceramic substrate is superior and the thermal expansion coefficient is also small. Thus, cracks are not easily generated, and the ratio of the resistance change of the resistance heating elements is also small.

Furthermore, in the case that the heat resistant resin is used for the insulating covering, the insulating covering can be formed at a relatively low temperature.

As described above, the present invention is most suitable for heaters for use at low temperatures of 100 to 200° C., for use at middle temperatures of 200 to 400° C., and for use at high temperatures of 400 to 800° C.

### Industrial Applicability

As described above, the ceramic heater of the present invention has a small ratio of the resistance change, and superior temperature controllability. The ceramic heater has superior resistance against corrosion with reactive gas in a semiconductor producing device, and its insulating covering is an insulator, thus, the resistance value of its resistance heating elements can be made high, so that the present invention can be used as heaters for middle temperature use and high temperature use.

In the case that insulating coverings are formed in given stretches containing portions where the resistance heating elements are formed, the above-mentioned advantageous effects are produced and migration of a metal such as silver can be prevented. Costs for forming the insulating coverings can be reduced since the coverings are easily formed.

1-8. (Canceled)

9. A ceramic heater for use in the semiconductor industry, comprising:
a disc-form ceramic substrate having a heating surface and comprising a nitride ceramic or a carbide ceramic;
a resistance heating element comprising at least one circuit, said resistance heating element being arranged on an outermost surface of said ceramic substrate; and
an insulating covering deposited on the resistance heating element,
wherein said resistance heating element is positioned on an opposite side of said heating surface; and
said insulating covering comprises a heat resistant resin material with a thickness of 10 to 30 μm.

10. The ceramic heater of claim 9, wherein said insulating covering is deposited in a stretch containing a portion where said at least one circuit is formed.

11. The ceramic heater of claim 9, wherein said heat resistant resin material is at least one resin material selected from the group consisting of polyimide resin and silicone resin.

12. The ceramic heater of claim 9, wherein said insulating covering covers the resistance heating element comprising two or more circuits in a lump.

13. The ceramic heater of claim 9, further comprising a thermocouple.

14. The ceramic heater of claim 13, wherein said ceramic substrate defines at least one through hole; and
said ceramic heater further comprises:
a lifter pin inserted through said through hole, said lifter pin being configured to support a semiconductor wafer at a distance above said ceramic substrate.

15. The ceramic heater of claim 13, further comprising:
at least one bottom hole in a bottom surface of said ceramic substrate.

16. The ceramic heater of claim 9, wherein said resistance heating element is a metal or a conductive ceramic.

17. The ceramic heater of claim 9, wherein said resistance heating element is a sintered body produced from metal particles or conductive ceramic particles.

18. The ceramic heater of claim 9, further comprising:
an insulating layer on the opposite side of said heating surface,
wherein said resistance heating element is positioned on said insulating layer.
